(19) United States
(12) Patent Application Publication
(10) Pub. No.: US 2025/0256520 A1
(43) Pub. Date: Aug. 14, 2025

(54) MEDIUM CONVEYANCE DEVICE AND IMAGE FORMING APPARATUS

(71) Applicant: Tatsuya HARA, Kanagawa (JP)

(72) Inventor: Tatsuya HARA, Kanagawa (JP)

(21) Appl. No.: 19/022,321

(22) Filed: Jan. 15, 2025

(30) Foreign Application Priority Data
Feb. 9, 2024 (JP) 2024-018928

(51) Int. Cl. B41J 11/14; B41J 3/407; B41J 11/06

(52) U.S. Cl. CPC B41J 11/14; B41J 3/4078; B41J 11/06

(57) ABSTRACT

A medium conveyance device includes a housing, a stage, a stage conveyor, a medium conveyor, a driver, and a switcher. A medium is placed on the stage. The stage conveyor holds the stage to convey the stage: from a first position outside the housing to a second position inside the housing; and from the second position to the first position. The medium conveyor conveys the stage conveyor and the stage: from the second position to a third position at a rear side from the second position; and from the third position to the second position. The driver generates a driving force to drive the stage conveyor and the medium conveyor. The switcher transmits the driving force to: the stage conveyor when the stage is positioned between the first position and the second position; and the medium conveyor when the stage is positioned between the second position and the third position.

### CROSS-REFERENCE TO RELATED APPLICATION

This patent application is based on and claims priority pursuant to 35 U.S.C. § 119(a) to Japanese Patent Application No. 2024-018928, filed on Feb. 9, 2024, in the Japan Patent Office, the entire disclosure of which is hereby incorporated by reference herein.

### BACKGROUND

### Technical Field

The present disclosure relates to a medium conveyance device and an image forming apparatus.

### Related Art

In the related art, an image forming apparatus is known which applies an image forming material to a medium to form an image on the medium. The image forming apparatus includes a discharge head and a medium conveyor. The discharge head discharges a liquid as the image forming material onto a medium, and the medium conveyor conveys the medium toward the discharge head. In addition, a medium conveyance device is also known which includes a stage conveyor and a medium conveyor. A cloth (e.g., a T-shirt) is placed on a stage, and the stage conveyor conveys the stage to the inside of the device, and the medium conveyor conveys the stage conveyor relative to the discharge head. An image forming apparatus that forms an image on a cloth as a medium is typically called a garment printer.

### SUMMARY

The present disclosure described herein provides an improved medium conveyance device including a housing, a stage, a stage conveyor, a medium conveyor, a driver, and a switcher. A medium is placed on the stage. The stage conveyor holds the stage to convey the stage: from a first position outside the housing to a second position inside the housing in a first direction; and from the second position to the first position in a second direction opposite to the first direction. The medium conveyor conveys the stage conveyor and the stage: from the second position to a third position at a rear side from the second position in the first direction; and from the third position to the second position in the second direction. The driver generates a driving force to drive the stage conveyor and the medium conveyor. The switcher transmits the driving force to: the stage conveyor when the stage is positioned between the first position and the second position; and the medium conveyor when the stage is positioned between the second position and the third position.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are diagrams each illustrating an overall configuration of an image forming apparatus;

FIGS. 2A and 2B are diagrams each illustrating the feature of the image forming apparatus of FIGS. 1A and 1B;

FIGS. 3A and 3B are diagrams each illustrating an overall configuration of a medium conveyance device;

FIGS. 4A and 4B are diagrams each illustrating an operation state of the medium conveyance device of FIGS. 3A and 3B;

FIG. 5 is a flowchart of a first part of processing executed by the medium conveyance device of FIGS. 3A and 3B;

FIG. 6 is a flowchart of a second part of processing executed by the medium conveyance device of FIGS. 3A and 3B;

FIG. 7 is a flowchart of a third part of processing executed by the medium conveyance device of FIGS. 3A and 3B;

FIG. 8 is a flowchart of another processing executed by the medium conveyance device of FIGS. 3A and 3B; and

FIG. 9 is a flowchart of yet another processing executed by the medium conveyance device of FIGS. 3A and 3B.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to a comparative example, a stage on which the medium is placed is moved and conveyed into a housing of a medium conveyance device by a stage conveyor and a medium conveyor. Accordingly, in the medium conveyance device including the stage, even when the medium conveyance device is on standby for processing or is not in operation, the stage is positioned outside the housing (exterior) of the device, and a part of the stage conveyor projects outward from an end of the housing of the device. In other words, the part of the stage conveyor is also disposed outside the housing of the device even when an image forming process is on standby or suspended, or the power source of the device is turned off. A part of the device projecting outward from the housing hinders the entire apparatus from being downsized.

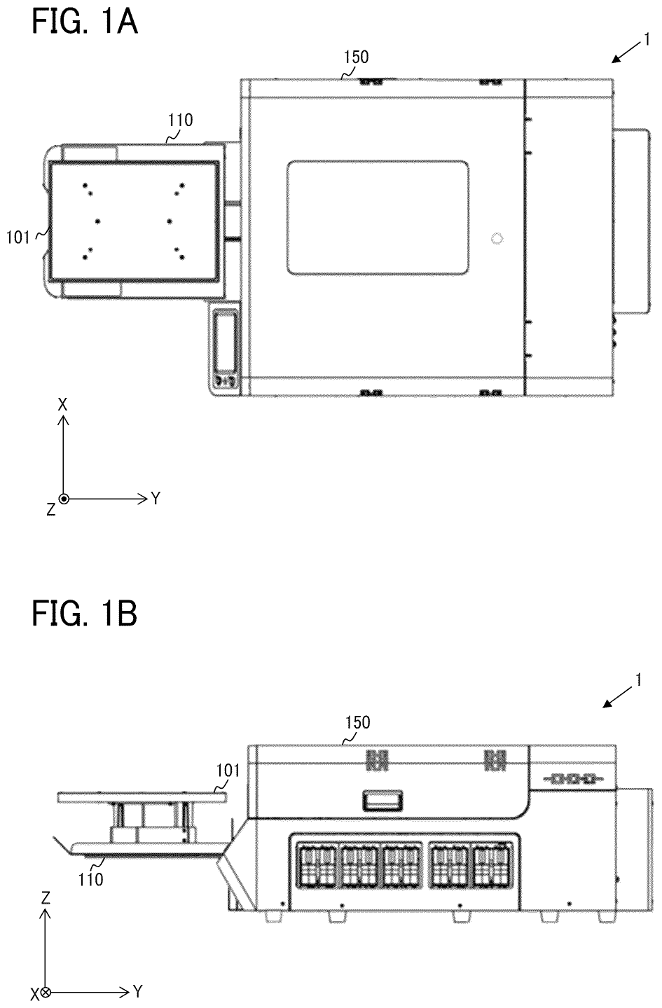

An image forming apparatus according to an embodiment of the present disclosure is described below with reference to the drawings. FIGS. 1A and 1B are external views of a garment printer 1 as the image forming apparatus using a cloth as a recording medium. FIGS. 1A and 1B illustrate a state of the garment printer 1 when a medium on which an image is to be recorded is placed on a platen 101, i.e., a stage on which the medium is placed. The medium used in the garment printer 1 is a cloth such as a “T-shirt.” The garment printer 1 has a function of forming an image on the T-shirt placed (set) on the platen 101 as the stage.

The garment printer 1 includes the platen 101 as the stage and a platen conveyor 110 as a stage conveyor that conveys the platen 101. As illustrated in FIGS. 1A and 1B, the platen 101 and a part of the platen conveyor 110 are disposed outside a housing 150. In other words, the platen 101 and the part of the platen conveyor 110 project from the housing 150.

When the medium is set on the platen conveyor 110, the platen conveyor 110 moves the platen 101 so that a user can easily perform the operation. At this time, a part of the platen conveyor 110 that moves the platen 101 projects outward from the end of the housing 150 of the garment printer 1. In other words, the part of the platen conveyor 110 and the platen 101 fixed to the platen conveyor 110 correspond to projecting portions of the garment printer 1.

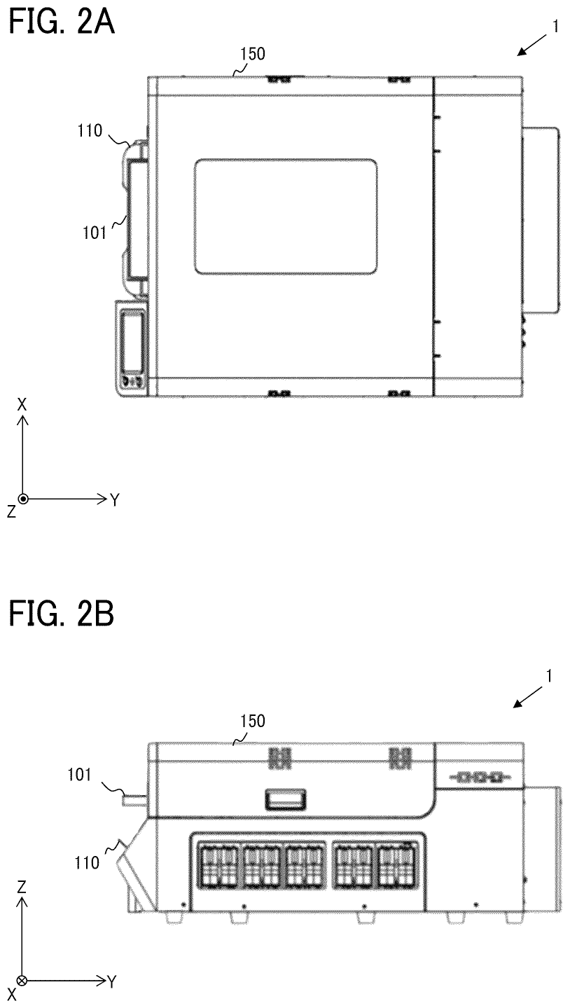

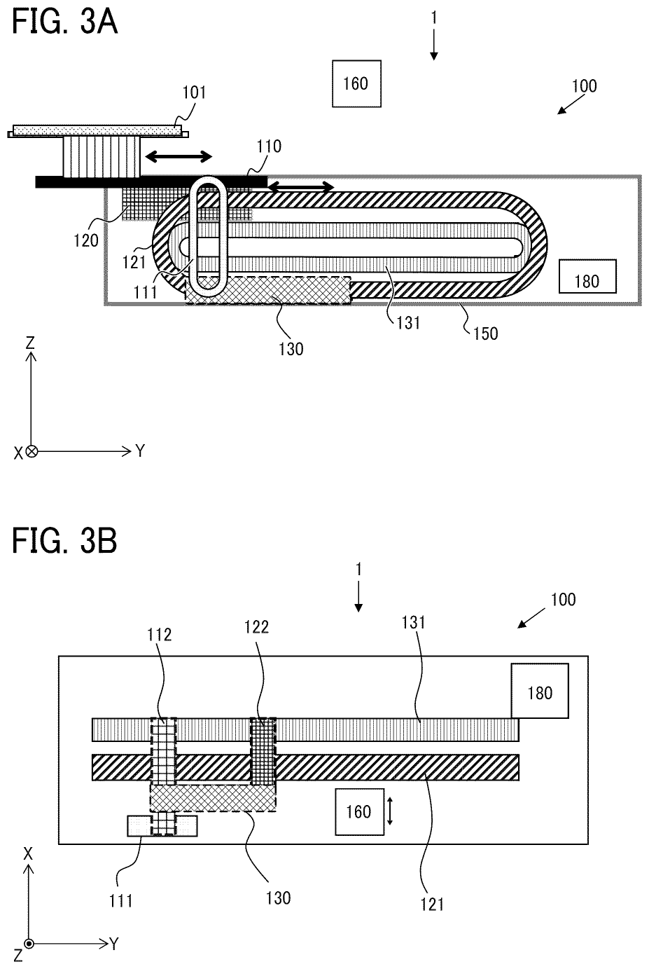

FIGS. 2A and 2B illustrate the feature of the garment printer 1 including a medium conveyance device 100 (see FIGS. 3A and 3B). A medium conveyance device according to the comparative example does not become the state corresponding to FIGS. 2A and 2B. FIGS. 2A and 2B illustrate a standby state or a power-off state of the garment printer 1 (i.e., the medium conveyance device 100 is powered off). As illustrated in FIGS. 2A and 2B, when a medium is not set on the platen 101, the platen 101 and the platen conveyor 110 are mostly accommodated (housed) in the housing 150. In other words, when a medium is not set on the platen 101 and the medium conveyance device 100 is not in operation (e.g., when the power is off or when an image forming process is not performed), a part of the platen conveyor 110 and the platen 101 do not project from the housing 150. Thus, the garment printer 1 does not have a projecting portion when the image forming process is not performed.

As described above, the medium conveyance device 100 moves the platen 101 together with the platen conveyor 110 to allow the garment printer 1 to accommodate the platen 101 and the platen conveyor 110. The platen conveyor 110 is a base of the platen 101 when a medium is placed on the platen 101. As a result, when the garment printer 1 is not performing an image forming process, or when the garment printer 1 is on standby, the size of the entire medium conveyance device 100 is reduced, and thus the installation area can be reduced.

### Accommodation Mechanism for Platen and Platen Conveyor

FIG. 3A is a side cutaway view of the medium conveyance device 100 that accommodates the platen 101 and the platen conveyor 110 in the housing 150. FIG. 3B is a top cutaway view of the medium conveyance device 100.

As illustrated in FIGS. 3A and 3B, the medium conveyance device 100 includes the housing 150, the platen 101 as the stage, the platen conveyor 110 as the stage conveyor, a platen conveyance belt 111 as a stage drive belt, a medium conveyor 120 as a medium conveyor, a medium conveyance belt 121 as a medium drive belt, a drive switcher 130 as a driving force switcher or simply as a switcher, and a driving force transmission belt 131 and a motor 180 as a driver that generates the driving force. The medium conveyor 120 conveys the platen 101 together with the platen conveyor 110 inside the housing 150.

The platen 101 is fixed to the platen conveyor 110. In other words, the platen conveyor 110 holds the platen 101. The platen conveyor 110 conveys the platen 101 relative to the housing 150 in a front-rear direction of the medium conveyance device 100 (i.e., the Y direction in FIGS. 3A and 3B). Specifically, the direction toward a rear side of the medium conveyance device 100 is a first direction (the positive Y direction in FIGS. 3A and 3B), and the direction toward a front side of the medium conveyance device 100 is a second direction (the negative Y direction in FIGS. 3A and 3B) opposite to the first direction. The platen conveyor 110 moves relative to the housing 150 to convey the platen 101.

The platen conveyor 110 is movably held relative to the medium conveyor 120. Accordingly, when the platen conveyor 110 moves relative to the medium conveyor 120 in the Y direction, the platen 101 fixed to the platen conveyor 110 also moves in the same direction as the platen conveyor 110.

The platen conveyor 110 moves by receiving a driving force transmitted from the driving force transmission belt 131 via the platen conveyance belt 111. The medium conveyor 120 moves by receiving a driving force transmitted from the driving force transmission belt 131 via the medium conveyance belt 121, and the platen conveyor 110 also moves in accordance with the movement of the medium conveyor 120.

The medium conveyor 120 conveys the platen conveyor 110 in the front-rear direction of the housing 150 (i.e., the Y direction). As a result, a medium placed on the platen 101 is conveyed relative to a liquid discharge unit 160 as a processing unit that performs a predetermined process (e.g., discharges a liquid) on the medium. The medium is conveyed by the medium conveyor 120, and a discharge head of the liquid discharge unit 160 discharges liquid ink (i.e., a liquid) onto the medium at appropriate timing while the medium moves relative to the discharge head to form an image on the medium. The discharge head of the liquid discharge unit 160 is a serial head that moves in the direction orthogonal to the front-rear direction as illustrated in FIG. 3B. Alternatively, the liquid discharge unit may include a line head that extends in the direction orthogonal to the front-rear direction and does not move.

The driving force transmission belt 131, which is a transmission source of the driving force to the platen conveyor 110 and the medium conveyor 120, transmits the driving force from a driving source such as the motor 180 to the platen conveyance belt 111 or the medium conveyance belt 121 via the drive switcher 130. As described above, the conveyance of the platen 101 is divided into the movement by the medium conveyance belt 121 and the movement by the platen conveyance belt 111.

A platen driving force transmitter 112 as a stage driving force transmitter and a medium driving force transmitter 122 as a medium driving force transmitter are attached to the drive switcher 130. The driving force from the driving force transmission belt 131 is switched between to be transmitted to the platen driving force transmitter 112 and to be transmitted to the medium driving force transmitter 122 by the drive switcher 130.

When the driving force is transmitted to the platen driving force transmitter 112, the driving force transmission belt 131 coupled to the motor 180 is coupled to the platen conveyance belt 111, and thus the driving force is transmitted to the platen conveyance belt 111. Since the platen conveyance belt 111 is coupled to the platen conveyor 110, when driving force is transmitted to the platen conveyance belt 111, the platen conveyor 110 moves relative to the medium conveyor 120 by receiving the driving force.

When the driving force is transmitted to the medium driving force transmitter 122, the driving force transmission belt 131 coupled to the motor 180 is coupled to the medium conveyance belt 121, and thus the driving force is transmitted to the medium conveyance belt 121. Since the medium conveyance belt 121 is coupled to the medium conveyor 120, when the driving force is transmitted to the medium conveyance belt 121, the medium conveyor 120 moves relative to the housing 150 by receiving the driving force. At this time, the platen conveyor 110 also moves together with the medium conveyor 120 relative to the housing 150.

As described above, the motor 180 as the driving source generates the driving force, and the drive switcher 130 as the driving force switcher switches between coupling the motor 180 and the platen conveyance belt 111 via the platen driving force transmitter 112 and coupling the motor 180 and the medium drive belt 121 via the medium driving force transmitter 122.

### Operation of Medium Conveyance Device

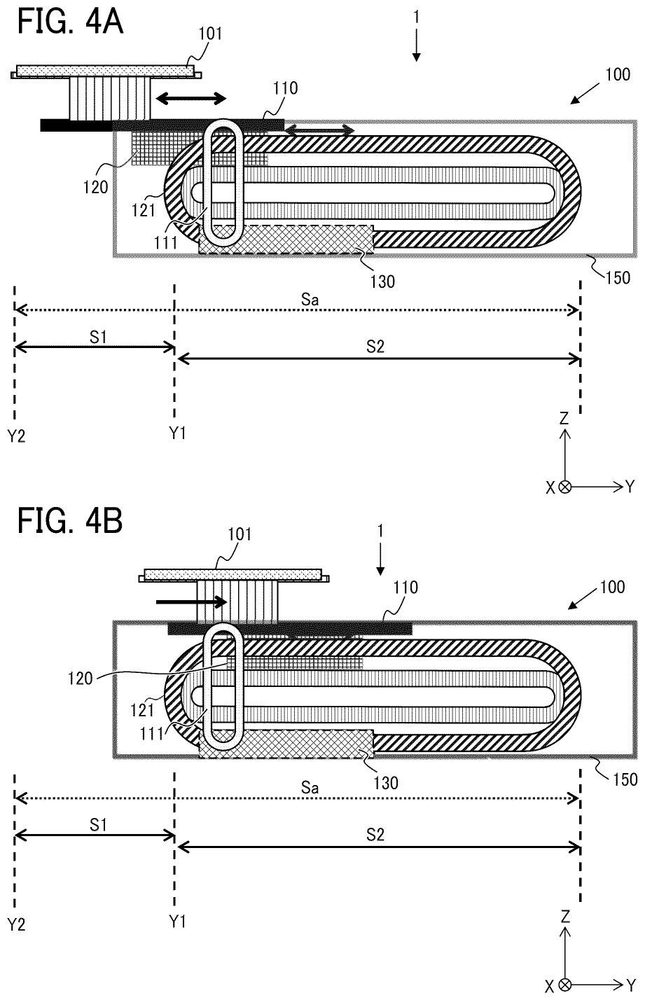

FIGS. 4A and 4B illustrate an operation of the medium conveyance device 100. FIG. 4A illustrates the medium conveyance device 100 which does not accommodate the platen 101 inside the housing 150. FIG. 4B illustrates the medium conveyance device 100 which accommodates the platen 101 inside the housing 150. In FIG. 4A, the illustration of an upper part of the housing 150 that accommodates (houses) the platen 101 is omitted for ease of understanding of the position of the platen 101.

A section Sa illustrated in FIGS. 4A and 4B indicates a movement range of the platen 101. A position Y1 (i.e., a second position), which is one of the predetermined positions, indicates a position at which the drive switcher 130 switches the destination of the driving force for moving the platen 101. A position Y2 (i.e., a first position) indicates a position at which a medium is set on the platen 101. When the medium is set on the platen 101, the platen 101 is disposed at the position Y2 which is another one of the predetermined positions.

In a section S1 illustrated in FIGS. 4A and 4B, the driving force for moving the platen 101 is transmitted to the platen conveyor 110 by the platen conveyance belt 111. In a section S2, inside the housing 150, illustrated in FIGS. 4A and 4B, the driving force for moving the platen 101 is transmitted to the medium conveyor 120 by the medium conveyance belt 121.

For example, when the platen 101 in the state of FIG. 4A moves to be accommodated in the housing 150, the platen 101 is moved by the driving force from the platen conveyance belt 111 in the section S1. When the platen 101 reaches the position Y1, the drive switcher 130 switches the driving force from the driving force transmission belt 131 to be transmitted to the medium conveyance belt 121 instead of the platen conveyance belt 111. Subsequently, the platen 101 is moved by the medium conveyance belt 121 in the section S2 as illustrated in FIG. 4B.

The medium conveyance device 100 can reduce a projecting portion of the platen 101 or the platen conveyor 110 projecting outward from the housing 150, and in particular, can reduce the size of the device during standby. Further, the garment printer 1 having an appearance close to a box shape can be easily transported while keeping the balance.

### Driving Force Switching Mechanism: Printing Process

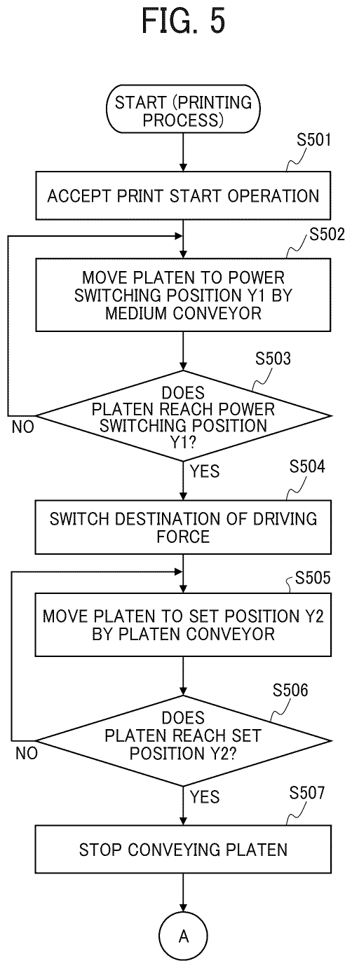

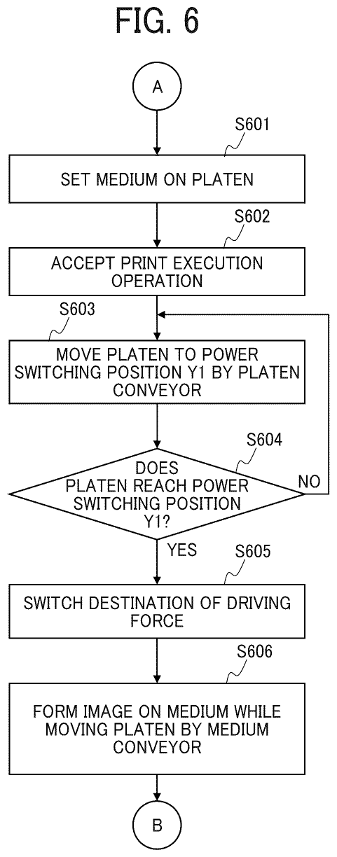

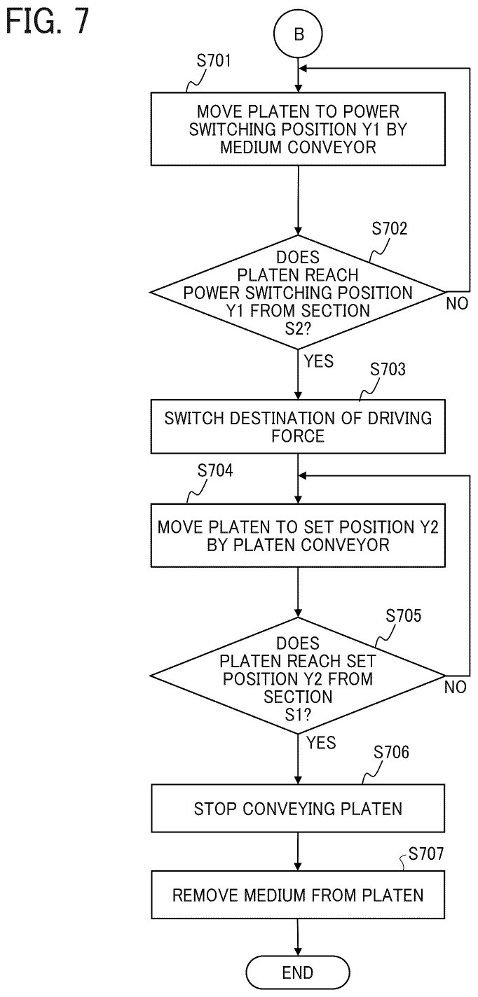

A process involving the conveyance of the platen 101 by the medium conveyance device 100 will be described below. FIGS. 5 to 7 illustrate a printing process when the garment printer 1 including the medium conveyance device 100 forms an image on a cloth.

Before the printing process, the platen 101 is accommodated in the housing 150. In other words, the platen 101 is positioned in the section S2. First, a user performs a “print start” operation with a predetermined operating procedure to start the printing process. In other words, in step S501, the garment printer 1 accepts the print start operation. Subsequently, the medium conveyor 120 moves the platen 101 to the position Y1 (see FIGS. 4A and 4B) for power switching (driving force switching).

Steps S502 and S503 are repeated until the platen 101 reaches the position Y1 (No in step S503). When the platen 101 reaches the position Y1 (Yes in S503), in step S504, the drive switcher 130 switches the coupling with the driving force transmission belt 131 so that the driving force from the motor 180 is transmitted to the platen conveyance belt 111. In other words, the drive switcher 130 switches the destination of the driving force when the platen 101 passes by the position Y1.

In step S505, the platen conveyor 110 moves the platen 101 to the position Y2 (see FIGS. 4A and 4B). Steps S505 and S506 are repeated until the platen 101 reaches the position Y2 (No in step S506). When the platen 101 reaches the position Y2 (Yes in step S506), in step S507, the platen conveyor 110 stops conveying the platen 101.

In step S601, the user sets a medium (e.g., a T-shirt) on the platen 101. Then, the user performs a print execution operation. In other words, the garment printer 1 accepts the print execution operation.

In step S603, the platen conveyor 110 moves the platen 101 to the position Y1 (see FIGS. 4A and 4B). Steps S603 and S604 are repeated until the platen 101 reaches the position Y1 (No in step S604). When the platen 101 reaches the position Y1 (Yes in S604), in step S605, the drive switcher 130 switches the coupling with the driving force transmission belt 131 so that the driving force from the motor 180 is transmitted to the medium conveyance belt 121.

In step S606, the garment printer 1 performs the image forming process by the liquid discharge unit 160 while the medium conveyor 120 moves the platen 101. After the image forming process is completed, in step S701, the medium conveyor 120 moves the platen 101 to the position Y1. Steps S701 and S702 are repeated until the platen 101 reaches the position Y1 (No in step S702). When the platen 101 reaches the position Y1 (Yes in S702), in step S703, the drive switcher 130 switches the coupling with the driving force transmission belt 131 so that the driving force from the motor 180 is transmitted to the platen conveyance belt 111.

Subsequently, in step S704, the platen conveyor 110 moves the platen 101 to the position Y2 (see FIGS. 4A and 4B). Steps S704 and S705 are repeated until the platen 101 reaches the position Y2 (No in step S705). When the platen 101 reaches the position Y2 (Yes in step S705), the platen conveyor 110 stops conveying the platen 101 (S706).

After the platen 101 reaches the position Y2 (i.e., a working position or a set position), and the platen 101 stops being conveyed, in step S707, the user takes out the medium set on the platen 101. Thus, the printing process ends.

### Driving Force Switching Mechanism: Standby Process

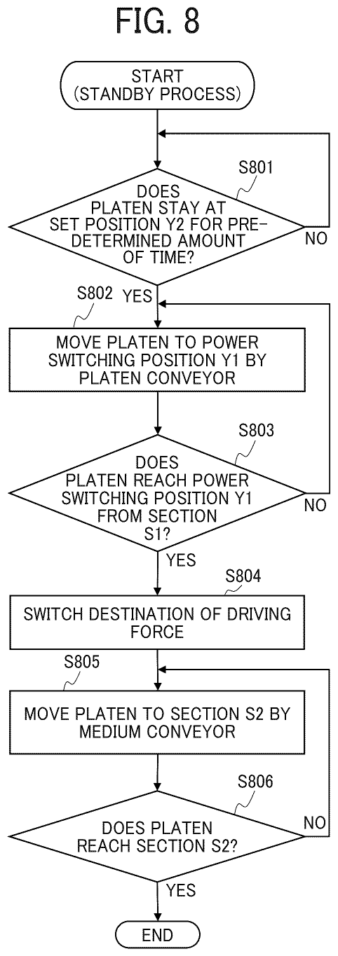

A process executed during standby of the medium conveyance device 100 after the printing process ends will be described below with reference to FIG. 8.

First, the process loops until a predetermined time elapses while the platen 101 stays at the position Y2 (No in step S801). When the predetermined time has elapsed (Yes in step S801), the platen conveyor 110 moves the platen 101 to the position Y1 (see FIGS. 4A and 4B). Steps S802 and S803 are repeated until the platen 101 reaches the position Y1 (No in step S803).

When the platen 101 reaches the position Y1 (Yes in S803), in step S804, the drive switcher 130 switches the coupling with the driving force transmission belt 131 so that the driving force from the motor 180 is transmitted to the medium conveyance belt 121.

Subsequently, the platen 101 is moved to the section S2, and steps S805 and S806 are repeated until the platen 101 reaches a predetermined position (e.g., a third position disposed deeper into the housing 150 than the second position or at the rear side from the second position in the first direction) in the section S2 (No in step S806). When the platen 101 reaches the predetermined position in the section S2 (Yes in step S806), the standby process ends.

### Driving Force Switching Mechanism: Power Off Process

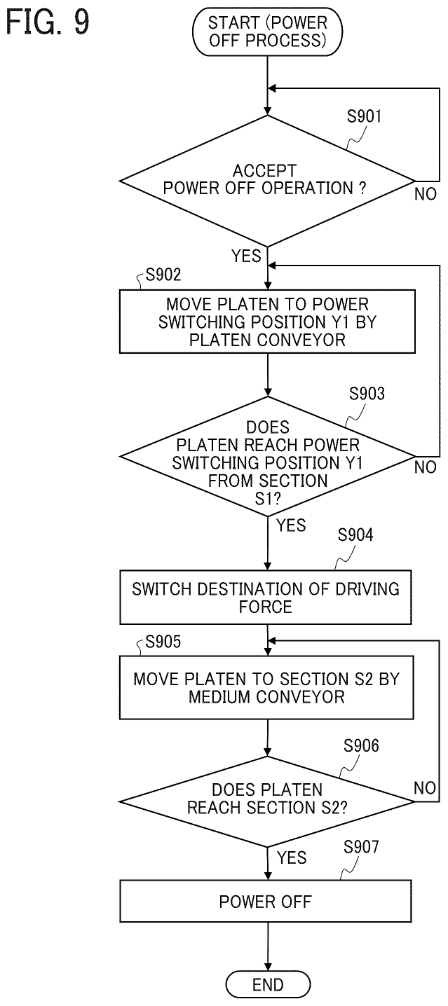

A process executed in a power off process of the medium conveyance device 100 at the end of use will be described below with reference to FIG. 9.

The platen 101 is at the position Y2 at the end of use of the medium conveyance device 100 (e.g., the end of the printing process). In step S901, the garment printer 1 determines whether to accept a power off operation when the platen 101 is at the position Y2. The garment printer 1 waits to accept the power off operation (No in step S901). When the garment printer 1 accepts the power off operation (Yes in step S901), in step S902, the platen conveyor 110 moves the platen 101 to the position Y1 (see FIGS. 4A and 4B). Steps S902 and S903 are repeated until the platen 101 reaches the position Y1 (No in step S903). When the platen 101 reaches the position Y1 (Yes in S903), in step S904, the drive switcher 130 switches the coupling with the driving force transmission belt 131 so that the driving force from the motor 180 is transmitted to the medium conveyance belt 121.

Subsequently, the platen 101 is moved to the section S2, and steps S905 and S906 are repeated until the platen 101 reaches a predetermined position in the section S2 (No in step S906). When the platen 101 reaches the predetermined position in the section S2 (Yes in step S906), in step S907, the garment printer 1 is powered off, and thus the power off process ends.

According to the medium conveyance device 100 described above, the destination of the driving force is switched when the platen 101 is conveyed. Accordingly, the installation area of the medium conveyance device 100 and the garment printer 1 can be reduced when the garment printer 1 is on standby. In other words, the apparatus can be downsized when not in use or during transportation.

Embodiments of the present disclosure are not limited to the above-described embodiments, and various modifications and variations can be made without departing from the technical scope of the present disclosure. It is therefore to be understood that the disclosure of this patent specification may be practiced otherwise by those skilled in the art than as specifically described herein. Such modifications are also included in the technical scope of the appended claims.

Aspects of the present disclosure are, for example, as follows.

### Aspect 1

A medium conveyance device conveys a medium relative to a processing unit that performs a predetermined process on the medium. The medium conveyance device includes a stage conveyor that fixes a stage on which the medium is placed and conveys the stage outside a predetermined position in a housing of the device, a medium conveyor that conveys the medium relative to the processing unit together with the stage conveyor, a driver that supplies a driving force to the stage conveyor and the medium conveyor, and a driving force switcher that switches the driving force from the driver to be transmitted to the stage conveyor when the stage is outside the predetermined position and to be transmitted to the medium conveyor when the stage is inside the predetermined position.

In other words, a medium conveyance device includes a housing, a stage, a stage conveyor, a medium conveyor, a driver, and a switcher. A medium is placed on the stage. The stage conveyor holds the stage to convey the stage: from a first position outside the housing to a second position inside the housing in a first direction; and from the second position to the first position in a second direction opposite to the first direction. The medium conveyor conveys the stage conveyor and the stage: from the second position to a third position at a rear side from the second position in the first direction; and from the third position to the second position in the second direction. The driver generates a driving force to drive the stage conveyor and the medium conveyor. The switcher transmits the driving force to: the stage conveyor when the stage is positioned between the first position and the second position; and the medium conveyor when the stage is positioned between the second position and the third position.

### Aspect 2

In the medium conveyance device according to Aspect 1, the driving force switcher switches the destination of the driving force when the stage passes by the predetermined position.

In other words, the switcher switches a destination of the driving force between the stage conveyor and the medium conveyor when the stage passes the second position.

### Aspect 3

In the medium conveyance device according to Aspect 1 or 2, the predetermined position is a position at which the stage is accommodated in the housing of the device.

In other words, the housing houses the stage positioned at the second position.

### Aspect 4

In the medium conveyance device according to any one of Aspects 1 to 3, the stage is positioned inside the predetermined position when the processing unit is not in operation.

In other words, in the image forming apparatus according to Aspect 6, the stage is positioned between the second position and the third position when the liquid discharge unit is on standby or powered off.

### Aspect 5

In the medium conveyance device according to any one of Aspects 1 to 4, the driver includes a stage drive belt that drives the stage conveyor, a stage driving force transmitter that transmits the driving force to the stage drive belt, a medium drive belt that drives the medium conveyor, and a medium driving force transmitter that transmits the driving force to the medium drive belt. The switcher switches whether to couple the stage drive belt and the stage driving force transmitter or to couple the medium drive belt and the medium driving force transmitter.

In other words, the driver includes a driving source to generate the driving force, a stage drive belt to drive the stage conveyor, a stage driving force transmitter to transmit the driving force to the stage drive belt, a medium drive belt to drive the medium conveyor, and a medium driving force transmitter to transmits the driving force to the medium drive belt. The driving force switcher switches between coupling the driving source and the stage drive belt via the stage driving force transmitter and coupling the driving source and the medium drive belt via the medium driving force transmitter.

### Aspect 6

An image forming apparatus includes a liquid discharge unit as the processing unit that performs the predetermined process on the medium and a medium conveyance unit that conveys the medium relative to the liquid discharge unit. The medium conveyance unit is the medium conveyance device according to any one of Aspects 1 to 5.

In other words, an image forming apparatus includes a liquid discharge unit to discharge a liquid onto the medium and the medium conveyance device according to Aspects 1 to 4, to convey the medium relative to the liquid discharge unit.

According to one aspect of the present disclosure, the installation area of the device can be reduced when an image forming process is not performed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. A medium conveyance device comprising:
a housing;
a stage on which a medium is placed;
a stage conveyor holding the stage to convey the stage:
from a first position outside the housing to a second position inside the housing in a first direction; and
from the second position to the first position in a second direction opposite to the first direction;
a medium conveyor to convey the stage conveyor and the stage:
from the second position to a third position at a rear side from the second position in the first direction; and
from the third position to the second position in the second direction; and
a driver to generate a driving force to drive the stage conveyor and the medium conveyor;
a switcher to transmit the driving force to:
the stage conveyor when the stage is positioned between the first position and the second position; and
the medium conveyor when the stage is positioned between the second position and the third position.

2. The medium conveyance device according to claim 1,
wherein the switcher switches a destination of the driving force between the stage conveyor and the medium conveyor when the stage passes the second position.

3. The medium conveyance device according to claim 1,
wherein the housing houses the stage positioned at the second position.

4. The medium conveyance device according to claim 1,
wherein the driver includes:
a driving source to generate the driving force;
a stage drive belt to drive the stage conveyor;
a stage driving force transmitter to transmit the driving force to the stage drive belt;
a medium drive belt to drive the medium conveyor; and
a medium driving force transmitter to transmit the driving force to the medium drive belt, and
the switcher switches between:
coupling the driving source and the stage drive belt via the stage driving force transmitter; and
coupling the driving source and the medium drive belt via the medium driving force transmitter.

5. An image forming apparatus comprising:
a liquid discharge unit to discharge a liquid onto the medium; and
the medium conveyance device according to claim 1, to convey the medium relative to the liquid discharge unit.

6. The image forming apparatus according to claim 5,
wherein the stage is positioned between the second position and the third position when the liquid discharge unit is on standby or powered off.
